(19) United States
(12) Patent Application Publication
(10) Pub. No.: US 2025/0242621 A1
(43) Pub. Date: Jul. 31, 2025

(54) SELF-INKING STAMPING DEVICE AND METHOD FOR OPENING A COVER

(71) Applicant: COLOP STEMPELERZEUGUNG SKOPEK GESELLSCHAFT M.B.H. & CO. KG., Wels (AT)

(72) Inventor: Johann WILFLINGSEDER, Dorf an der Pram (AT)

(73) Assignee: COLOP STEMPELERZEUGUNG SKOPEK GESELLSCHAFT M.B.H. & CO. KG., Wels (AT)

(21) Appl. No.: 18/702,253

(22) PCT Filed: Oct. 19, 2022
(86) PCT No.: PCT/AT2022/060359

§ 371 Date: Apr. 17, 2024

(30) Foreign Application Priority Data
Oct. 19, 2021 (AT) A 50832/2021

(51) Int. Cl. B41K 1/42; B41K 1/00; B41K 1/02; B41K 1/52

(52) U.S. Cl. CPC B41K 1/42; B41K 1/006; B41K 1/02; B41K 1/52

(57) ABSTRACT

A self-inking stamping device includes a housing, in which a stamping unit is mounted that is coupled to an actuation part, the actuation part being movable relative to the housing. The actuation part has a snap-in location for receiving a snap hook of a cover of the self-inking stamping device. A pusher is arranged on the actuation part in order to release a snap hook which is snapped in at the snap-in location.

### CROSS-REFERENCE TO RELATED APPLICATION

The present application is a National Stage Filing of PCT International Application No. PCT/AT2022/060359 filed on Oct. 19, 2022, which claims priority to Austrian Application No. A50832/2021, filed on Oct. 19, 2021. Both applications are incorporated herein by reference in their entirety.

### TECHNICAL FIELD

The invention relates to a self-inking stamp with a housing in which a stamp unit coupled to an actuating part displaceable relative to the housing is mounted, wherein the actuating part comprises a snap-in point for receiving a snap-in hook of a cover of the self-inking stamp. The invention also relates to a method for opening a cover of such a self-inking stamp and a corresponding use.

In order to hold a self-inking stamp, for example, in a space-saving delivery position (or transport position) with the stamp plate exposed and at the same time to avoid contamination of an area surrounding the stamp by any stamp ink adhering to the stamp plate, it is known to provide a cover.

### PRIOR ART

For example, DE 696 04 597 T2 shows a self-inking stamp with such a cover. In a closed transport position, the cover is connected to the actuating part by means of a snap connection between an elastic tongue of the cover and an edge provided as a locking member on the outside of the actuating part. To open the cover, the elastic tongue must be lifted until it comes out of en-gagement with the edge. To do this, the user must be able to grasp the elastic tongue on the side facing the actuating part.

AT 523 250 A1 provides a more convenient and simpler way of opening the cover. The covers proposed there comprise two opposing actuating elements in the form of pushers. When the pushers are actuated, the snap-in hooks, which are designed as latches that engage on the inside of the actuating part, are moved inwards and a latching connection between the upper part and the cover is released. The disadvantage here is the required mechanics and the resulting com-plex production of the cover.

### SUMMARY OF THE INVENTION

It is a task of the invention to provide a simple and convenient way of opening a cover that is easy and inexpensive to manufacture.

The invention provides a self-inking stamp of the type mentioned at the beginning, wherein a pusher for releasing a snap-in hook snapped in at the snap-in point is arranged on the actuating part. The pusher is movably connected to the actuating part. The pusher acts on the snap-in hook, for example when actuated, i.e. when pressed, and moves it relative to the snap-in point until the snap-in connection is released. It thus serves to transmit the force exerted by the user on the pusher to a connecting element of the snap connection, for example to the snap-in hook. This avoids the user having to grip the snap-in hook directly. The pusher can, for example, push a snap-in hook connected to a snap-in point on the inside of the actuating part inwards and out of the snap-in point.

The snap-in point generally refers to a part of a functional element for detachable, simple form-fit joining of the cover and the actuating part (or actuating bracket). The snap-in point forms a joining point of the actuating part. It can be formed, for example, as a projection, recess, groove or opening. The other part of the functional element that creates the snap connection is the snap-in hook of the cover. When the snap-in connection is made, the snap-in hook is elas-tically deformed and then detachably hooks onto the snap-in point. This joining creates a cohe-sion between the cover and the actuating part locally. Accordingly, the snap-in point has a partial contour that enables it to engage with a snap-in hook with a corresponding partial contour. For example, it accommodates a projection of the Snap-in hook. The snap connection formed by the snap-in point serves to secure the position of the cover in relation to the self-inking stamp as a whole and in particular in relation to the actuating part.

Alternatively, the snap-in point can be provided on an outer side of the actuating part. In this case, the snap-in hook can snap into a snap-in point from the outside, which simplifies the production of the snap connection because no parts need to be inserted into the inside of the actuating part, and which enables a more compact design of the actuating part because no space needs to be provided specifically for movement of the snap-in hook inside it.

The pusher can, for example, be formed as a tilting element. The tilting element enables the force exerted on the pusher from the outside to be transmitted in the opposite direction, i.e. outwards and away from the self-inking stamp, in a simple mechanical manner when actuated, for example to move a snap-in hook connected to a snap-in point on an outer side of the actuating part outwards from the snap-in point and thus release the snap connection.

Such a tilting element can optionally also perform other functions in addition to acting on any snap-in hook, for example also acting as a locking element to limit a displacement of the actuating part relative to the housing. In particular, this can be used to limit a movement that is driven by the spring force of a stamp spring held between the housing and the actuating part. The tilting element can, for example, penetrate or engage in a recess on the housing to limit the displacement of the actuating part and transmit a counterforce to the spring force of the stamp spring between the actuating part and the housing via the connection or mounting of the tilting element on the actuating part and the support of the tilting element in the recess. For this purpose, the tilting element can comprise a hook projection, for example, which extends in the direction of the housing. The function and design of a tilting element as a locking element is explained in detail in AT 522 302 A1.

In particular, the locking element can be configured for limiting the displacement in a first position, which corresponds to a slightly depressed intermediate position for exchanging an ink pad container of the self-inking stamp, and/or in a second position for attaching a stamp plate to a plate carrier of the stamp unit. To replace the ink pad container, the actuating part can be fixed in a slightly depressed intermediate position. This lifts a text plate from the ink pad and the ink pad container can thus be moved freely, for example to remove it from a side opening provided for this purpose in the housing. To attach a stamp plate to the plate carrier, it is useful to fix the actuating part in a maximally pushed position over the housing, in which the surface of the text plate protrudes from the impression opening of the housing. The tilting element can thus fulfill several different functions depending on the state of the self-inking stamp, so that no separate precautions or components are required for the individual functions.

According to an embodiment example, the snap-in point can be provided between an impression opening of the housing and the tilting element. In this case, a part or a continuation of the snap-in hook of the cover can be designed in such a way that it extends over the edge of the tilting element facing the cover when the cover is connected to the stamp and rests against it, for example. The snap-in hook thus follows a movement of the tilting element and is pushed outwards out of the snap-in point when the tilting element is pushed in a side opposite and remote from the cover with respect to the tilting axis of the tilting element.

In a particularly space-saving version of the self-inking stamp, the snap-in point can be formed by an edge of a recess in the actuating part facing the impression opening of the housing (or closest to it, or lower in the position of use of the stamp), whereby the tilting element is arranged recessed in the recess. The recess can optionally be formed as a clearance, an opening or a passage in the actuating part. If the tilting element also functions as a locking element or catch, the recess can be formed by the corresponding locking clearance, the edge of which facing the cover can thus form the snap-in point in which the snap-in hook of the cover can get caught. The snap-in hook of a cover, which snaps into the recess at the lower edge, can thus be lifted out of the recess and thus out of the locking on the actuating part by tilting the tilting element, thereby releasing the snap connection between the cover and the stamp.

Within the scope of the invention, the actuating part can also comprise two or more snap-in points for receiving corresponding snap-in hooks. For example, two or more pushers can be arranged on the actuating part, each of which can release a snap-in hook snapped in at the respective snap-in point. For example, a pusher can be provided on each of two opposite sides of the actuating part of a self-inking stamp, which is assigned to a snap-in point and is set up to release a snap-in hook of a cover snapped in there. Accordingly, a cover for the self-inking stamp can be provided with snap-in hooks arranged on each of two opposite sides of the cover. The variants and examples described above can in principle apply to each of the two or more snap-in points or all snap-in points as well as to any associated snap-in hooks.

The invention further relates to a self-inking stamp, wherein an impression opening of the housing is covered with a cover, wherein the cover comprises a snap-in hook, wherein the snap-in hook is received at the snap-in point of the actuating part. The snap-in hook and optionally the entire cover can be made of a plastic. This can ensure the elasticity of the snap-in hook required for making and releasing the snap connection. However, other materials are generally also conceivable as long as they comprise a suitable elasticity.

In addition, the invention relates to a method for opening a cover of a self-inking stamp, the self-inking stamp comprising a housing in which a stamp unit coupled to an actuating part which is displaceable relative to the housing is mounted, the actuating part comprising a snap-in point, wherein a snap-in hook of the cover is received at the snap-in point, wherein a snap-in connection formed by the snap-in hook and the snap-in point is released between the cover and the actuating part as a result of actuation of a pusher arranged on the actuating part.

Finally, the invention also relates to a use of a movable pusher arranged on the actuating part of a self-inking stamp for opening a cover, wherein the self-inking stamp comprises a housing in which a stamp unit coupled to an actuating part displaceable relative to the housing is mounted, wherein a snap-in hook of the cover is received at a snap-in point of the actuating part, wherein the cover covers an impression opening of the housing.

### BRIEF DESCRIPTION OF THE FIGURES

The invention will be further explained below with reference to particularly preferred em-bodiments, to which, however, it is not intended to be limited, and with reference to the drawings. The drawings show in detail:

FIG. 1 a front view of a self-inking stamp according to a first embodiment example of the present disclosure in a rest position or stamp inking position;

FIG. 2 a side view of the stamp according to FIG. 1;

FIG. 3 a section of the stamp according to FIG. 1 along line III-III in FIG. 2;

FIG. 4 a front view of a cover for a self-inking stamp according to FIG. 1;

FIG. 5 a side view of the cover as shown in FIG. 4;

FIG. 6 a top view of the cover as shown in FIG. 4;

FIG. 7 a perspective view of the cover as shown in FIG. 4;

FIG. 8 a front view of the stamp according to FIG. 1 loosely held in the cover according to FIG. 4 and in a rest position or stamp inking position;

FIG. 9 a side view of the stamp and the cover as shown in FIG. 8;

FIG. 10 a section of the stamp and the cover according to FIG. 8 along the line X-X in FIG. 9;

FIG. 11 a front view of the stamp according to FIG. 1 and the connected cover according to FIG. 4 in a delivery position or transport position;

FIG. 12 a side view of the stamp and the cover as shown in FIG. 11;

FIG. 13 a section of the stamp and the cover according to FIG. 11 along the line XIII-XIII in FIG. 12;

FIG. 14 a perspective view of the stamp and the cover as shown in FIG. 11;

FIG. 15 a section as in FIG. 13 in a transitional position immediately after actuation of the pushers to release the cover and before the stamp moves to the rest position as in FIG. 10; and

FIG. 16 a sectional view of a self-inking stamp and a connected cover according to a second embodiment of the present disclosure in a delivery position or transport position.

### DETAILED DESCRIPTION OF THE INVENTION

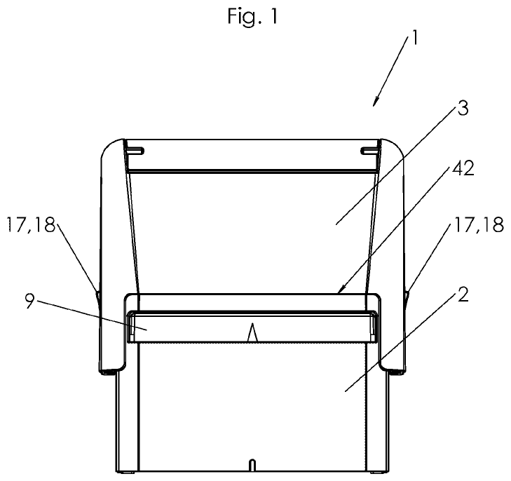

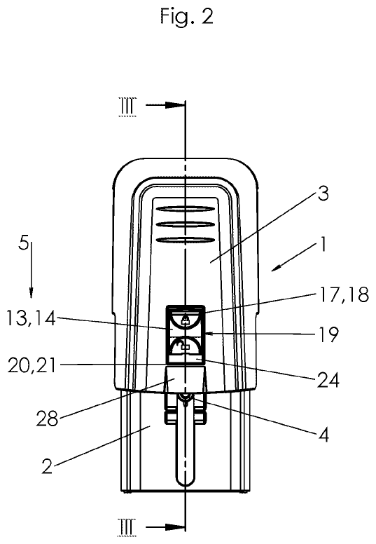

FIGS. 1 to 3 show a self-inking stamp 1 (or stamp for short) in a resting position or stamp inking position. More precisely, it is a self-inking stamp 1 with overhead inking. The stamp 1 comprises a housing 2, an actuating part 3 and a stamp unit 4. The actuating part 3 is displaceable relative to the housing 2 in an imprint direction 5. The stamp unit 4 is arranged in the housing 2 and is mounted coupled to the actuating part 3. The stamp unit 4 comprises a plate carrier 6 and optionally a stamp plate 7 mounted thereon. In the rest position shown here, the stamp plate 7 rests against an ink pad 8 in an ink pad container 9, whereby stamping ink is dispensed from the ink pad 8 onto the cliché of the stamp plate 7. To make an imprint, the actuating part 3 is gripped by a user and actuated by pressing it down in the imprint direction 5 towards a docu-ment to be stamped. In doing so, the user overcomes the spring force exerted by the stamp spring 10 or return spring and moves the actuating part 3 with the stamp unit 4 coupled to it into an impression position in which the cliché passes through an impression opening 11 of the housing 2 and releases the stamping ink on it onto the base. During this process, the stamp unit 4 is turned around a turning axis 12.

The ink pad container 9 can be pushed out of the housing 2 transversely to the turning axis 12 and transversely to the printing direction 5 after the actuating part 3 has been pressed down slightly in the printing direction 5 to an intermediate position (not shown) in which the stamp plate 7 is lifted out of the ink pad 8. In this intermediate position, the actuating part 3 can be fixed relative to the housing 2. For this purpose, fixing elements 13 in the form of tilting elements 14 are arranged on the two narrow sides 15, 16 of the actuating part 3. In the rest position or stamp inking position shown, the upper side 17 of the tilting elements 14 protrudes outwards from the actuating part 3 and thus forms pushers 18 that are easily accessible to the user. Apart from limiting the displacement in the intermediate position described for exchanging an ink pad container 9 of the self-inking stamp 1, the fixing elements 13 are also arranged to limit and fix the actuating part 3 in a second position for attaching the stamp plate 7 to the plate carrier 6 of the stamp unit 4.

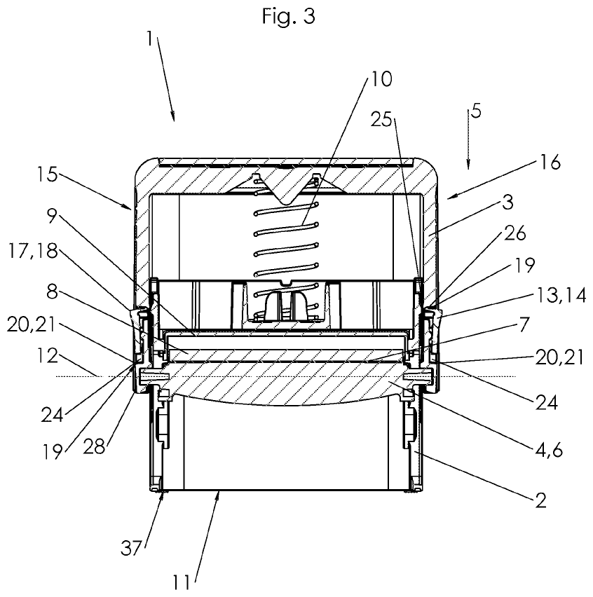

As can be seen in FIG. 3, the actuating part 3 comprises a recess 19 on both narrow sides 15, 16, in each of which a tilting element 14 is arranged countersunk. An edge 20 of the recesses 19 facing the impression opening 11 of the housing 2, i.e. the lower edge 20 in the figures, forms a snap-in point 21 on each of the two narrow outer sides of the actuating part 3 for receiving a snap-in hook 22 of a cover 23 of the self-inking stamp 1. These snap-in point 21 are thus provided between the impression opening 11 of the housing 2 and the respective associated tilting element 14. In order to create space for the snap-in hooks 22, indentations 24 are provided in the recesses 19 between the snap-in points 21 and the tilting elements 14. The lower edge of the tilting elements 14 is arranged at a greater distance from the lower edge 20 of the recesses 19 than the upper edge 17 of the tilting elements 14 is from the upper edge of the recesses 19. Passages 25 are provided on both sides within the recesses 19, through which hook projections 26 of the tilting elements 14 can penetrate into the interior of the actuating part 3 and can be inserted into clearances 27 provided for this purpose in the housing and received therein for limiting the movement of the actuating part 3 relative to the housing 2 in one of the positions described in detail above.

Below the snap-in points 21, i.e. between the snap-in points 21 and the impression opening 11 of the housing 2, a respective ramp 28 is provided on the outside of the actuating part 3, which correspond to surfaces inclined inwards at an angle starting from the snap-in points 21. The ramps 28 serve to continuously bend the snap-in hooks 22 outwards over a longer distance when attaching the cover 23, before they snap inwards at the snap-in points 21. The actuating part 3 is thus tapered on the underside in the area of the ramps 28, which makes it easier to pick up and insert the snap-in hooks 22 via the actuating part 3.

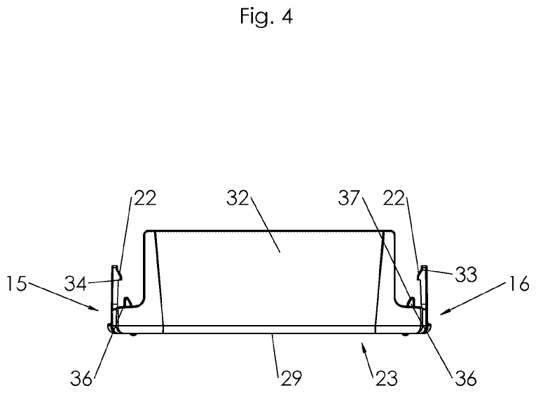

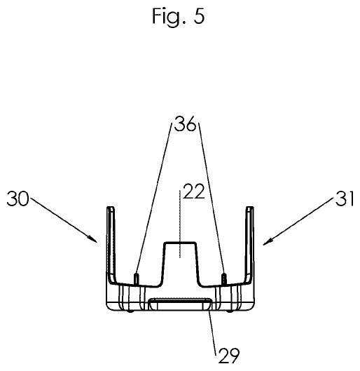

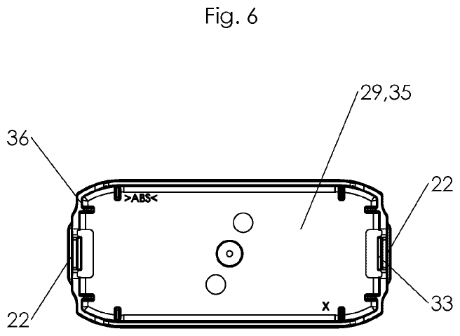

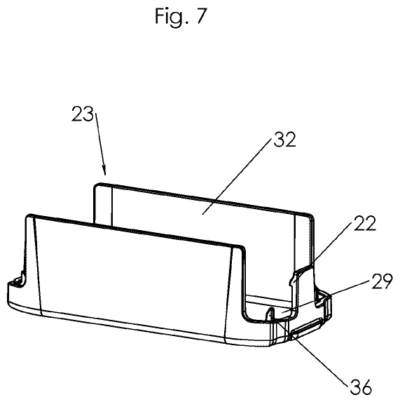

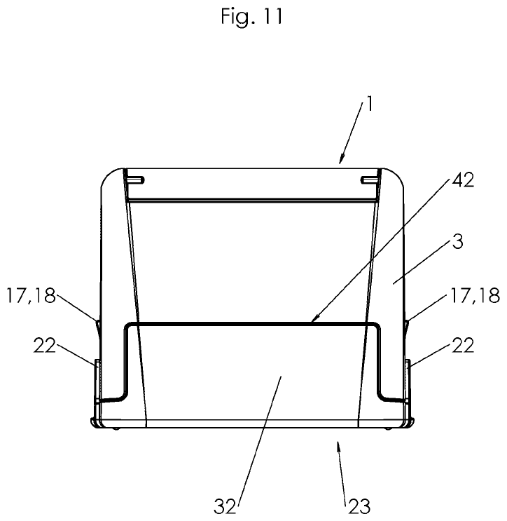

FIGS. 4 to 7 show a corresponding cover 23 for the self-inking stamp 1 according to FIGS. 1 to 3. The cover 23 comprises a base surface or cover surface 29 and a snap-in hook 22 on each of the two narrow sides 15, 16. The snap-in hooks 22 extend essentially normally on the cover surface 29. The cover 23 comprises a side wall 32 on each of the wide sides 30, 31. The contour of the side wall 32 corresponds to a recess 42 in the actuating part 3 for removing an ink pad container 9 of the stamp 1 (see FIG. 11). The snap-in hooks 22 comprise a bevel 33 on the inside facing the cover surface 29. The bevel

33 extends outwards from the cover surface 29 starting from a joining point 34 of the snap-in hook 22. The joining point 34 is the point that is in contact with the assigned snap-in point 21 on the actuating part 3 of the stamp 1 when the snap connection between the cover 23 and the stamp is established.

The side 35 of the cover surface 29 facing the self-inking stamp 1 in a transport position comprises four guide elements 36, which are provided outside a contact surface 37 of the housing 2 of the self-inking stamp 1. The guide elements 36 each comprise a bevel 38 which runs essentially parallel to the bevel 33 of an adjacent snap-in hook 22 and facilitates insertion and centering of the housing 2 in the cover 23.

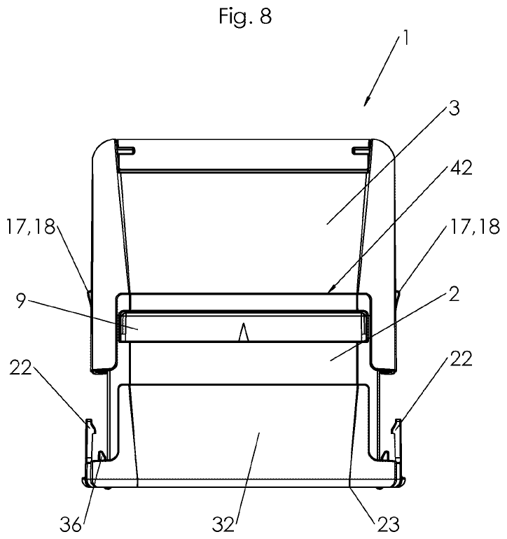

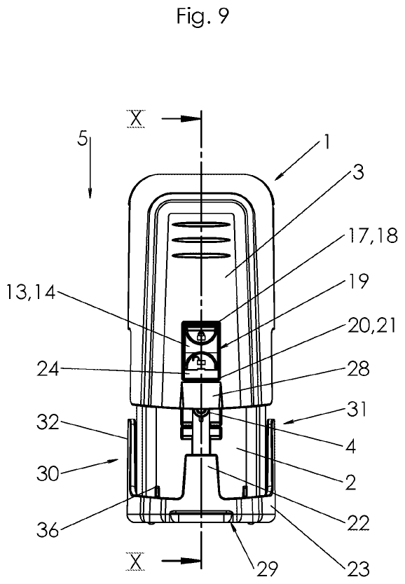

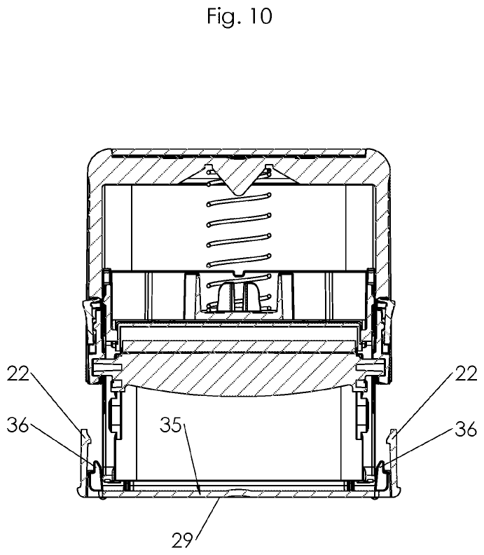

FIGS. 8 to 10 show the stamp 1 in a correspondingly centered position mounted in the cover 23 and in a rest position. Due to the centering achieved by the guide elements 36 of the cover 23, the snap-in hooks 22 are positioned on both narrow sides 15, 16 in the same way relative to the actuating part 3 and below the ramps 28.

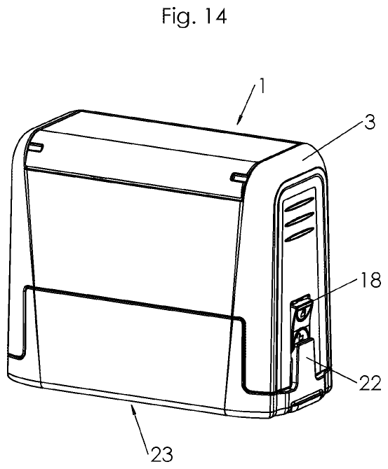

By pushing the actuating part 3 down from the rest position shown in FIGS. 8 to 10 into the cover 23, the snap-in hooks 22 are initially bent outwards along the ramps 28 until they finally snap into place at the snap-in points 21 as soon as the transport position shown in FIGS. 11 to 14 is reached. In this transport position, the impression opening 11 of the housing 2 is covered with the cover 23. The snap-in hooks 22 of the cover 23 are received at the snap-in points 21 of the actuating part 3. This creates snap connections 39 between the cover 23 and the actuating part 3 on the two narrow sides 15, 16.

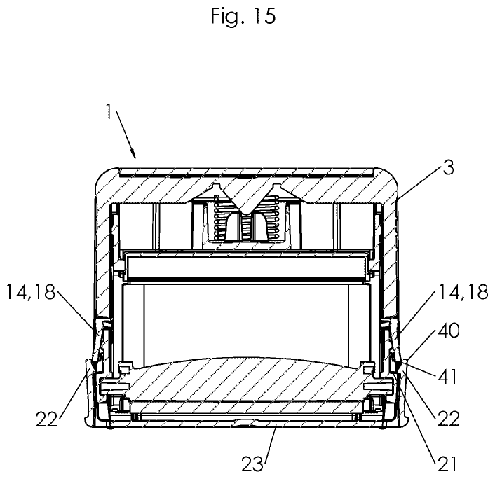

The upper end 40 of the snap-in hooks 22 extends over the lower edge 41 of the tilting elements 14. The pushers 18, arranged in the manner shown in FIG. 15, formed by the tilting elements 14 on the actuating part 3 are thus suitable for releasing a snap-in hook 22 that is snapped in at the snap-in point 21. This figure illustrates the disclosed method for opening the cover 23 of the self-inking stamp 1 described in detail above. As a result of an actuation of the two pushers 18 arranged on the actuating part 3 in the form of the two tilting elements 14, the snap-in hooks 22 of the cover 23 are pushed outwardly from the lower edge 41 of the tilting elements 14 and the snap connections 39 formed by the snap-in hooks 22 and the snap-in points 21 between the cover 23 and the actuating part 3 are released. In this way, the movable tilting elements 14 arranged on the actuating part 3 of the self-inking stamp 1 can be used to open the cover 23.

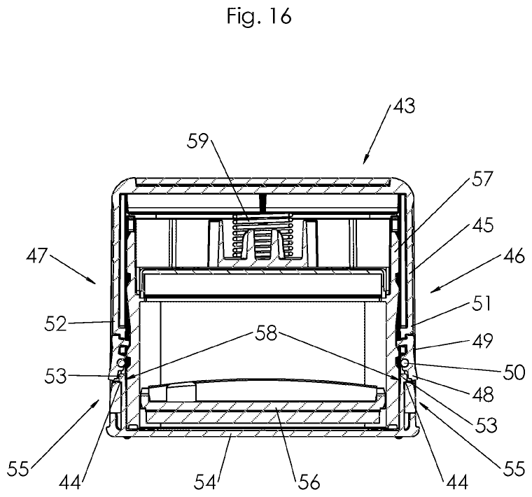

In the case of the self-inking stamp 43 shown in FIG. 16, the snap-in points 44 are provided on the inside of the actuating part 45. Pushers 48 are arranged on the actuating part 45 on both narrow sides 46, 47 of the stamp 43. In this example, the pushers 48 are each formed as part of a tilting element 49. The tilting elements 49 are each movable about an axis 50, in particular pivotable. The person skilled in the art may also provide other bearings for the pushers 48 within the scope of the present disclosure. For example, the pushers 48 may alternatively be connected to the side walls 51, 52 of the actuating part 45 via deformable tabs. The tilting elements 49 shown in FIG. 16 also function as locking elements, analogous to the tilting elements 14 of the first embodiment example. It is readily conceivable to alternatively provide pushers without an additional function.

By actuating the pushers 48, the snap-in hooks 53 of the cover 54 snapped in at the snap-in points 44 can be pressed inwards and pushed out of the snap-in points 44 until they are released. This separates the snap connection 55 between the cover 54 and the stamp 43 and the cover 54 can be removed from the stamp 43.

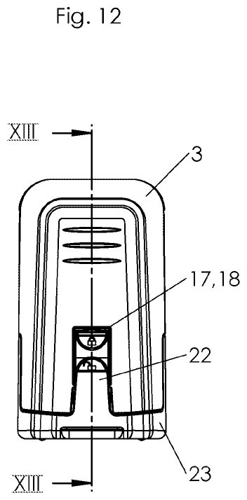

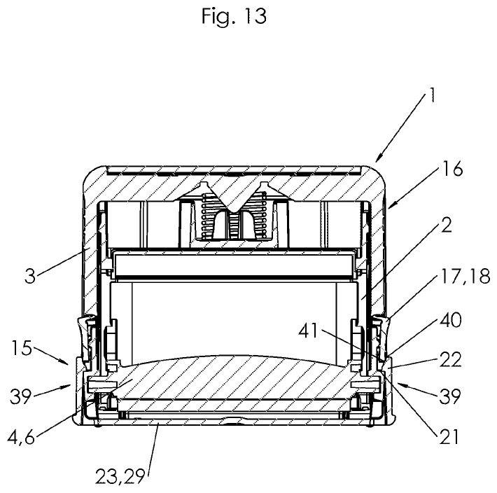

The section shown in FIG. 16 is-unlike that shown in FIG. 12 for FIG. 13—not through the center of the stamp 43, but offset parallel to the turning axis of the stamp unit 56. The snap-in hooks 53 can, for example, be provided on both sides of the turning axis, so that two on each side 46, 47 and a total of four snap-in hooks 53 are formed on the cover 54. The housing 57 of the stamp 43 has recesses 58 in the area of the snap-in hooks 53, which are arranged to temporarily receive the snap-in hooks 53 when the cover 54 is released. In this way, the cover 54 can be fixed to the housing 57 of the stamp 43 during the opening process until the actuating part 45 has been displaced far enough away from the cover 54 relative to the housing 57 by the influence of the stamp spring 59 that the snap-in hooks 53 are exposed. In addition, the inner sides of the snap-in hooks 53 facing each other can be designed to frictionally engage the housing 57. These measures have the advantage that the cover 54 is not thrown away from the stamp 43 in an un-controlled manner when the cover 54 is opened. In addition, in this arrangement, the snap-in hooks 53 simultaneously fulfill the function of the guide elements 36 of the first embodiment example, namely centering the housing 57 in the cover 54 when it is inserted into the cover 54.

1. A self-inking stamp with a housing in which a stamp unit coupled to an actuating part displaceable relative to the housing is mounted, wherein the actuating part comprises a snap-in point for receiving a snap-in hook of a cover of the self-inking stamp,
wherein a pusher for releasing a snap-in hook snapped in at the snap-in point is arranged on the actuating part.

2. The self-inking stamp according to claim 1, wherein the snap-in point is provided on an outer side of the actuating part.

3. The self-inking stamp according to claim 2, wherein the pusher comprises a tilting element.

4. The self-inking stamp according to claim 3, wherein the tilting element comprises a locking element for limiting a displacement of the actuating part relative to the housing.

5. The self-inking stamp according to claim 4, wherein the locking element is configured for limiting the displacement in a first position, which corresponds to a depressed intermediate position for exchanging an ink pad container of the self-inking stamp, and/or in a second position for attaching a stamp plate to a plate carrier of the stamp unit.

6. The self-inking stamp according to claim 3, wherein the snap-in point is provided between an impression opening of the housing and the tilting element.

7. The self-inking stamp according to claim 6, wherein the snap-in point is formed by an edge, facing an impression opening of the housing, of a recess in the actuating part, the tilting element being arranged recessed in the recess.

8. The self-inking stamp according to claim 1, wherein an impression opening of the housing is covered with a cover, wherein the cover comprises a snap-in hook, wherein the snap-in hook is received at the snap-in point of the actuating part.

9. A method for opening a cover of a self-inking stamp, the self-inking stamp comprising a housing in which a stamp unit coupled to an actuating part displaceable relative to the housing is mounted, wherein the actuating part comprises a snap-in point, wherein a snap-in hook of the cover is received at the snap-in point,
wherein a snap connection formed by the snap-in hook and the snap-in point between the cover and the actuating part is released by actuation of a pusher arranged on the actuating part.

10. A pusher mounted on an actuating part of a self-inking stamp for opening a cover, wherein the self-inking stamp comprises a housing in which a stamp unit coupled to an actuating part displaceable relative to the housing is mounted, wherein a snap-in hook of the cover is received at a snap-in point of the actuating part, wherein the cover covers an impression opening of the housing.
